(19) United States
(12) Patent Application Publication
(10) Pub. No.: US 2013/0259305 A1
(43) Pub. Date: Oct. 3, 2013

(54) COMMODITY MANAGEMENT APPARATUS

(71) Applicant: TOSHIBA TEC KABUSHIKI KAISHA, Tokyo (JP)

(72) Inventor: Yukio Harada, Kanagawa-ken (JP)

(73) Assignee: TOSHIBA TEC KABUSHIKI KAISHA, Tokyo (JP)

(21) Appl. No.: 13/803,977

(22) Filed: Mar. 14, 2013

(30) Foreign Application Priority Data
Mar. 30, 2012 (JP) 2012-080014

(51) Int. Cl. G06K 9/32

(52) U.S. Cl. CPC G06K 9/3241
USPC 382/103

(57) ABSTRACT

A commodity management apparatus comprises an extraction section configured to extract a plurality of objects shown in a display state image which is obtained by color-photographing a display space in which a plurality of commodities are displayed, wherein the plurality of commodities respectively have labels which indicate objects of different colors according to the timing at which labels are respectively adhered to the commodities, a discrimination section configured to discriminate color of each object extracted by the extraction section, and a counting section configured to respectively count the plurality of objects extracted by the extraction section according to each color discriminated by the discrimination section.

### CROSS-REFERENCE TO RELATED APPLICATION

This application is based upon and claims the benefit of priority from Japanese Patent Application No. 2012-080014, filed Mar. 30, 2012, the entire contents of which are incorporated herein by reference.

### FIELD

Embodiments described herein relate to a commodity management apparatus.

### BACKGROUND

Generally, a barcode label is attached to a packed commodity to manage commodities and sales thereof. Moreover, in order to manage freshness of perishable foods and pre-cooked foods, a production or pre-cooked date/time and a recommended limit date for eat (hereinafter referred to as a recommended limit date) before which foods are relishable are contained in the barcode on the barcode label. It is therefore required that the barcode is read by a terminal equipped with a function which displays information when such dates are confirmed.

### BRIEF DESCRIPTION OF THE DRAWINGS

FIG. 1 is a block diagram of a commodity management apparatus according to an embodiment;

FIG. 2 is a diagram schematically illustrating an example of the description content of a data table;

FIG. 3 is a diagram showing an example of a display state image;

FIG. 4 is a flowchart of a label issuance processing;

FIG. 5 is a diagram showing a specific example of a label;

FIG. 6 is a diagram showing a specific example of another label;

FIG. 7 is a flowchart of a commodity management processing;

FIG. 8 is a diagram showing an example of a display screen on which a list image is displayed; and

FIG. 9 is a diagram showing an example of a display screen on which a guidance image is displayed.

### DETAILED DESCRIPTION

In accordance with an embodiment, a commodity management apparatus comprises an extraction section configured to extract a plurality of objects shown in a display state image which is obtained by color-photographing a display space in which a plurality of commodities are displayed, wherein the plurality of commodities respectively have labels which indicate objects of different colors according to the timing at which labels are respectively adhered to the commodities, a discrimination section configured to discriminate color of each object extracted by the extraction section, and a counting section configured to respectively count the plurality of objects extracted by the extraction section according to each color discriminated by the discrimination section.

An embodiment of the present invention is described below with reference to the accompanying drawings. The embodiment is based on a case in which the display state of packed commodities is managed by a POS (Point of Sales) system.

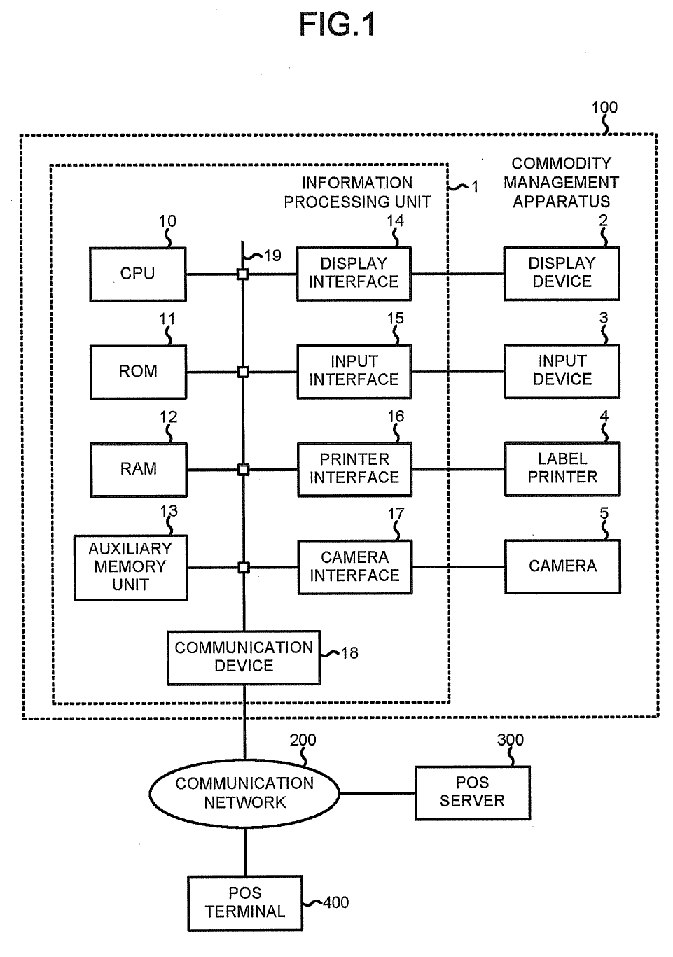

FIG. 1 is a block diagram of a commodity management apparatus 100 according to the present embodiment.

The commodity management apparatus 100 comprises an information processing unit 1, a display device 2, an input device 3, a label printer 4 and a camera 5.

The information processing unit 1 performs information processing for commodity management. The display device 2 is, for example, an LCD (Liquid Crystal Display), to display various images under the instruction of the information processing unit 1. The input device 3 is, for example, a keyboard or a pointing device (mouse), to transmit a command indicating the content of the operation of the input device 3 by a store clerk to the information processing unit 1. The label printer 4 prints a label in color to be adhered on a commodity. The camera 5 takes a color-photograph of a commodity display space, thereby obtaining an image in color showing the display state of a plurality of commodities in the display space (hereinafter referred to as a display state image). The camera 5 is an example of a photographing unit.

The information processing unit 1 comprises a CPU (Central Processing Unit) 10, a ROM (Read Only Memory) 11, a RAM (Random Access Memory) 12, an auxiliary memory unit 13, a display interface 14, an input interface 15, a printer interface 16, a camera interface 17, a communication device 18 and bus lines 19. The bus lines 19 include an address bus line, a data bus line and so on, and the CPU 10, the ROM 11, the RAM 12, the auxiliary memory unit 13, the display interface 14, the input interface 15, the printer interface 16, the camera interface 17 and the communication device 18 are connected with each other through the bus lines 19.

The CPU 10 controls each unit of the apparatus 100 based on an operating system and an application program stored in the ROM 11 and the RAM 12 to realize functions of the commodity management apparatus 100.

The operating system is stored in the ROM 11. Occasionally, the application program is also stored in the ROM 11. Besides, there may be also a case in which data which is referred to by the CPU 10 to perform various processing is stored in the ROM 11.

Data which is referred to by the CPU 10 to perform various processing is stored in the RAM 12. Further, the RAM 12 is used as a work area to store data temporarily used by the CPU 10 to execute various processing. The application program may be stored in the RAM 12 as well. However, if the application program is stored in the RAM 12, a battery is required to backup the RAM 12.

The auxiliary memory unit 13 is, for example, an HDD (hard disk drive) or an SSD (solid state drive) to store data used by the CPU 10 in executing various processing and data generated by the processing of the CPU 10. The application program is occasionally stored in the auxiliary memory unit 13.

A general-purpose server apparatus and a computer apparatus may be used as a basic hardware of the commodity management apparatus 100. An application program (hereinafter referred to as a commodity management program), in which a label issuance processing and a commodity management processing described later are included, is stored in the ROM 11, RAM 12 or the auxiliary memory unit 13 of the basic hardware to realize the commodity management apparatus 100. In this case, the commodity management apparatus 100 is generally transferred or sold in a state that the commodity management program is stored in the ROM 11, the RAM 112 or the auxiliary memory unit 13. However, if the basic hardware and the commodity management program are transferred or sold independently, the commodity management program may be written into the ROM 11, the RAM 12 or the auxiliary memory unit 13 after such transfer is done. The commodity management program may be transferred in the form of a removable recording medium such as a magnetic disk, a magneto-optical disk, an optical disk or a semiconductor memory or via a network. Additionally, an application program in which the label issuance processing is included and an application program in which the commodity management processing is included may be respectively stored in the ROM 11, the RAM 12 or the auxiliary memory unit 13.

The display device 2 is connected with the display interface 14, which is an interface for the data transmission between the CPU 10 and the display device 2.

The input device 3 is connected with the input interface 15, which is an interface for the data transmission between the CPU 10 and the input device 3.

The label printer 4 is connected with the printer interface 16, which is an interface for the data transmission between the CPU 10 and the label printer 4.

The camera 5 is connected with the camera interface 17, which is an interface for the data transmission between the CPU 10 and the camera 5.

The communication device 18 is connected with a communication network 200, through which the communication device 18 communicates with a POS server 300. The communication network 200 may be, for example, a LAN (Local Area Network), and in this case, the communication device 18 may be an existing LAN adapter.

The POS server 300 accumulates the sales data generated in a POS terminal 400 or manages data used in the POS terminal 400 while communicating with the POS terminal 400 via the communication network 200.

The POS terminal 400 performs various data processing relevant to the sales of commodities, such as registration of the commodities sold, calculation and settlement of a sales amount or a point apply processing. The POS terminal 400 has a function of acquiring data relevant to the commodities sold by respectively reading the barcodes contained in the commodity labels adhered on the commodities.

A data table, which is referred to during a commodity management processing described later, is stored in the RAM 12 or the auxiliary memory unit 13.

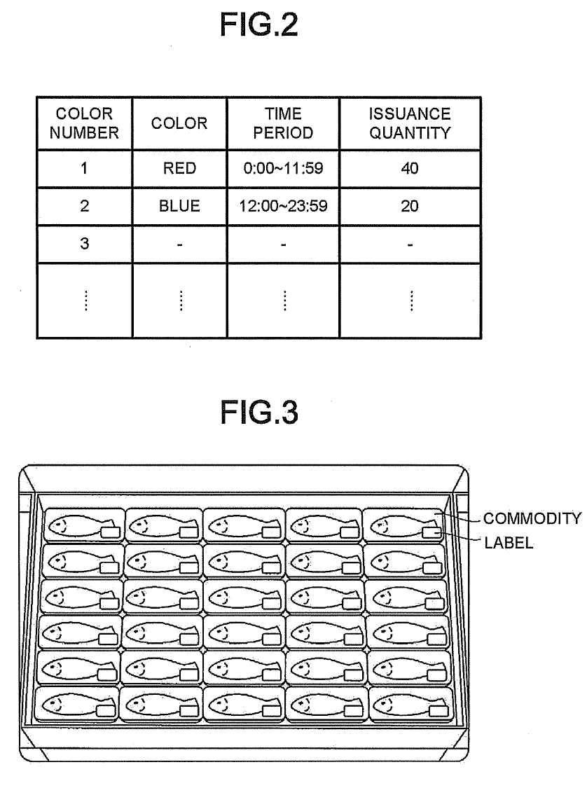

FIG. 2 is a schematic diagram illustrating an example of the description content of the data table.

The data table contains a plurality of data records in which information relevant to items such as ‘color number’, ‘color’, ‘time period’, and ‘issuance quantity’, is recorded.

Information relevant to the item ‘color number’ represents one of consecutive numbers 1-j (j is an arbitrary integer)

Information relevant to the item ‘color’ represents a color assigned to a color number. The assignment between a color number and a color may be fixedly set when the commodity management apparatus 100 is produced or freely set by the user.

Information relevant to the item ‘time period’ represents a time period assigned to a color number. The assignment between a color number and a time period may be fixedly set when the commodity management apparatus 100 is produced or freely set by the user. Additionally, in the embodiment, the assignment is set as follows: the smaller a color number is, the earlier a time period is.

Information relevant to the item ‘issuance quantity’ represents the number of the issued labels having a frame border in color contained in the same data record. The issuance quantity is updated with the issuance of a label.

The data table shown in FIG. 2 is a table for a daily management on the display state of the commodities that a label is attached thereto on the same day. If there is a possibility that commodities to which labels are respectively attached at any different timings in a relatively long period of time are displayed at the same time in the same display space, information relevant to ‘time period’ contains day, month or year information.

Next, the operation of the commodity management apparatus 100 with the construction above is described below.

A label issued by the label printer 4 is adhered to a commodity to be managed by the commodity management apparatus 100. Then, the commodity with the label is displayed in a display space (photographed object area) in such a manner that the display state image thereof shown in FIG. 3 is photographed by the camera 5.

For example, when issuance of a label is instructed by a store clerk through the input device 3, the CPU 10 starts a label issuance processing according to the management processing program.

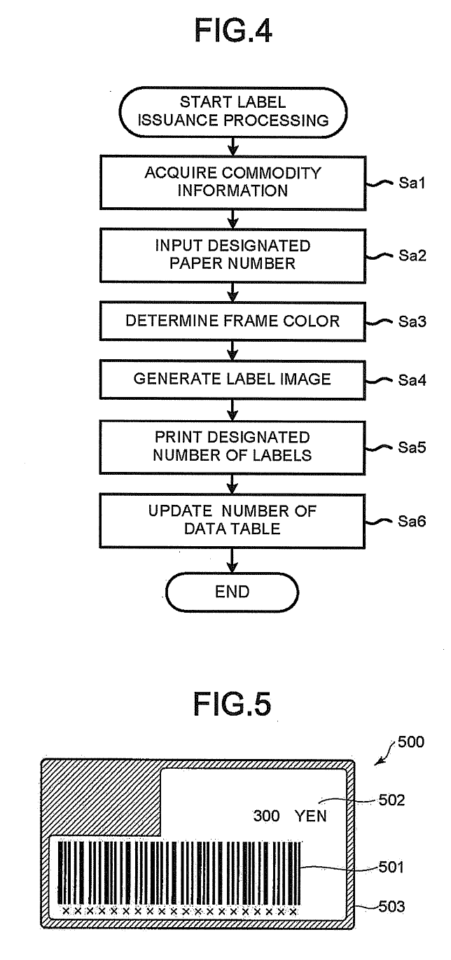

FIG. 4 is a flowchart of the label issuance processing.

In ACT Sa1, the CPU 10 acquires commodity information to be shown on a label that is issued. Specifically, the CPU 10 requests the store clerk to designate one of the commodities managed by the POS server 300 and acquires commodity information of the designated commodity from the POS server 300 through the communication network 200 and the communication device 18. The CPU 10 stores the acquired commodity information in the RAM 12 or the auxiliary memory unit 13.

In ACT Sa2, the CPU 10 inputs the designation by the store clerk relating to the number of labels to be issued.

In ACT Sa3, the CPU 10 determines the frame color of the labels. Specifically, the CPU 10 acquires the current time information managed by the operating system. Alternatively, a clock unit may be provided inside or outside the commodity management apparatus 10 to acquire the current time information from the clock unit. The CPU 10 confirms whether or not the current time is contained in anyone of the time periods recorded in the data table. Then, the CPU 10 determines a color recorded in a data record the same as the data record in which a time period containing the current time is recorded as a frame color of the labels. Thus, for example, if content of the data table is the table shown in FIG. 2, and the current time is 9:20, then the CPU 10 determines a color ‘red’ as the frame color of the labels. Additionally, the CPU 10 may determine the color recorded in a data record the same as the data record in which a time period designated by the store clerk is recorded as the frame color of the labels. Further, the CPU 10 may determine a color designated by the store clerk as the frame color of a label to be issued. Further, if a time period or color is designated by the store clerk, a time period containing the current time or a color assigned to the time period is designated by the store clerk.

In ACT Sa4, the CPU 10 generates a label image formed by configuring the commodity information acquired in ACT Sa1 and a frame border of the frame color determined in ACT Sa3 in a given way.

In ACT Sa5, the CPU 10 instructs the label printer 4 to print the label image generated in ACT Sa4 by the number designated in ACT Sa2. Upon receiving the instruction, the label printer 4 prints the label image on the designated number of label papers within the label papers set therein beforehand.

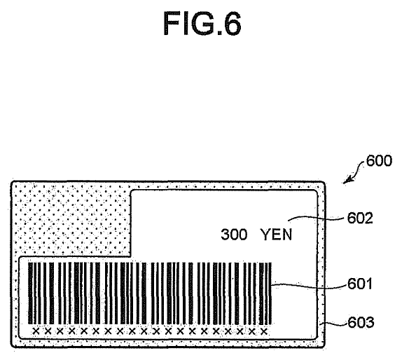

FIG. 5 and FIG. 6 are diagrams showing specific examples of labels 500 and 600.

The labels 500 and 600 shown in FIG. 5 and FIG. 6 are respectively adhered on the same kind of commodity. The labels 500 and 600 are issued in the case in which the content of the data table is that shown in FIG. 2, wherein the label 500 is issued within a time period from 0:00 to 11:59, and the label 600 is issued within a time period from 12:00 to 23:59, for example.

The label 500 contains a barcode 501, a character string 502 and a frame border 503. The label 600 contains a barcode 601, a character string 602 and a frame border 603.

The barcodes 501 and 601 represent data containing the identification code of a commodity. The barcode 501 may be the same as or different from the barcode 601. For example, the data represented by the barcodes 501 and 601 may contain the date/time when the label of a commodity is issued and the production date/time or the recommended limit date of the commodity, in this case, the barcodes 501 and 601 are different from each other to include such information, respectively. However, the data represented by the barcodes 501 and 601 contains the identification code of the same commodity.

Character strings 501 and 602 represent the selling price of a commodity.

The frame borders 503 and 603 take the same shape, while the color of the frame border 503 is red and the color of the frame border 603 is blue, for example.

In ACT Sa6, the CPU 10 updates the ‘issuance quantity’ in the data table. Specifically, the CPU 10 extracts, from the data table, the data record containing the frame color determined in ACT Sa3, and updates the value recorded in the item ‘issuance quantity’ contained in a matched data record to the sum of the value recorded till then and the designated number. Further, the value recorded in the item ‘issuance quantity’ in the data table is cleared to 0 (zero) at a predetermined timing at which, for example, the power supply of the commodity management apparatus 100 is switched on.

Then, when the update on the data table is ended, the CPU 10 ends the label issuance processing.

Generally, the packing of a commodity, the issuance of a label and the adhesion of the label to the commodity are conducted in relatively a short period of time as a series of jobs. Therefore, color of the frame border of the label is relevant to the time period in which the packing of the commodity and the adhesion of the label on the commodity are carried out. Further, since the recommended limit date of the commodity is determined to be a given period of time from the packing date/time, the color of the frame border of the label is also relevant to the recommended limit date.

Next, for example, when a store clerk requires, by operating the input device 3 in a given way, for the execution of a commodity management processing, the CPU 10 starts the commodity management processing according to the management processing program.

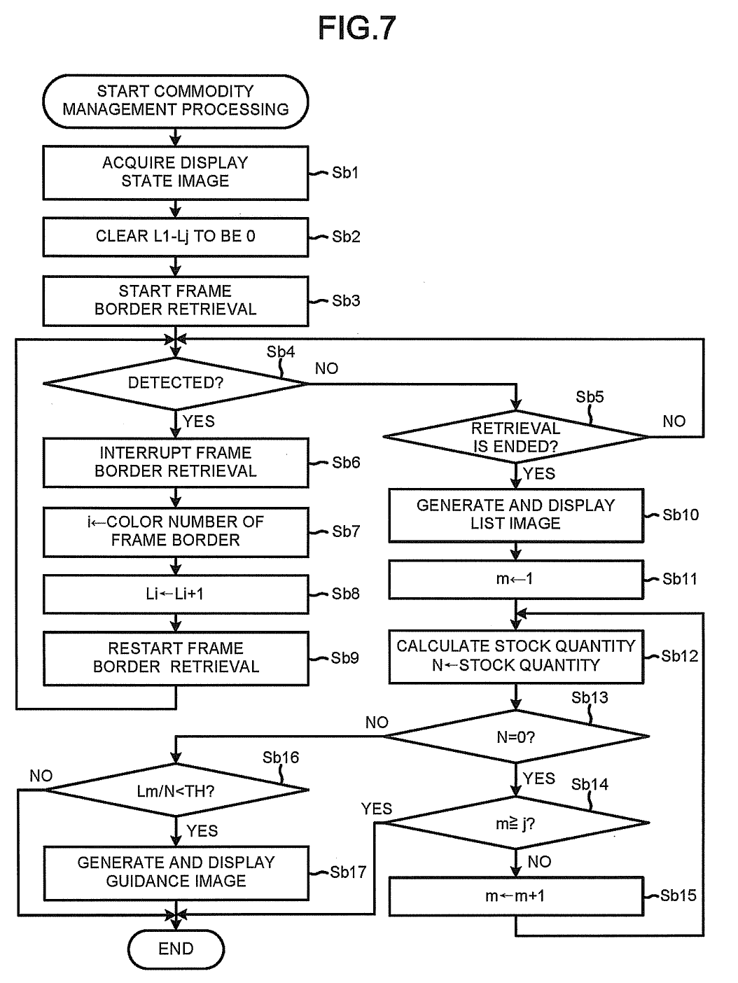

FIG. 7 is a flowchart of the commodity management processing.

In ACT Sb1, the CPU 10 acquires a display state image. Specifically, the CPU 10 instructs the camera 5 to take a photograph. Upon receiving the instruction, the camera 5 photographs the display space of the commodities to generate image data of a display state image and then sends the image data. The CPU 10 acquires the image data sent by the camera 5 via the interface 17 and stores the image data in the RAM 12 or the auxiliary memory unit 13.

In ACT Sb2, the CPU 10 clears all variables L1-Lj to be 0.

In ACT Sb3, the CPU 10 starts to retrieve the frame border. Retrieval of the frame border is a processing performed to the image data obtained in ACT Sb1 as the object to detect the frame border of a label imaged into the display state image represented by the image data. The CPU 10 executes the frame border retrieval in parallel with the commodity management processing as a processing of another task different from the commodity management processing. The frame border is an example of an object the color of which changes according to the timing for adhering a label, and the CPU 10 functions as an extraction section. In addition, a well-known pattern retrieval technology may be used in the frame border retrieval.

In ACTs Sb4 and Sb5, the CPU 10 waits for a detection of the frame border subject to the frame border retrieval or the end of the frame border retrieval. If the frame border is detected at one, then the CPU 10 executes ACT Sb6.

In ACT Sb6, the CPU 10 interrupts the frame border retrieval.

In ACT Sb7, the CPU 10 discriminates the color of the detected frame border and sets the color number assigned to the color as value of a variable i. In this way, the CPU 10 functions as a discrimination section.

In ACT Sb8, the CPU 10 increases value of a variable Li by 1. Specifically, if the frame border 503 is detected, a variable L1 is increased by 1. If the frame border 603 is detected, a variable L2 is increased by 1. In this manner, the value of a variable Li represents the number of detected frame borders of a color corresponding to a color number ‘i’. That is, the CPU 10 counts frame borders for each color, and thus the CPU 10 functions as a counting section.

In ACT Sb9, the CPU 10 restarts the frame border retrieval interrupted in ACT Sb6. After that, the CPU 10 returns to the wait state or standby state in ACTs Sb4 and Sb5.

If the frame border retrieval is conducted over the whole area of the display state image, then the CPU 10 determines the result of ACT Sb5 is YES, and then executes ACT Sb10.

In ACT Sb10, the CPU 10 generates a list image and instructs the display device 2 via the display interface 14 to display the list image. The list image shows values of variables L1-Li in association with the time periods respectively assigned to color numbers 1-j. In this way, the CPU 10 functions as a generation section.

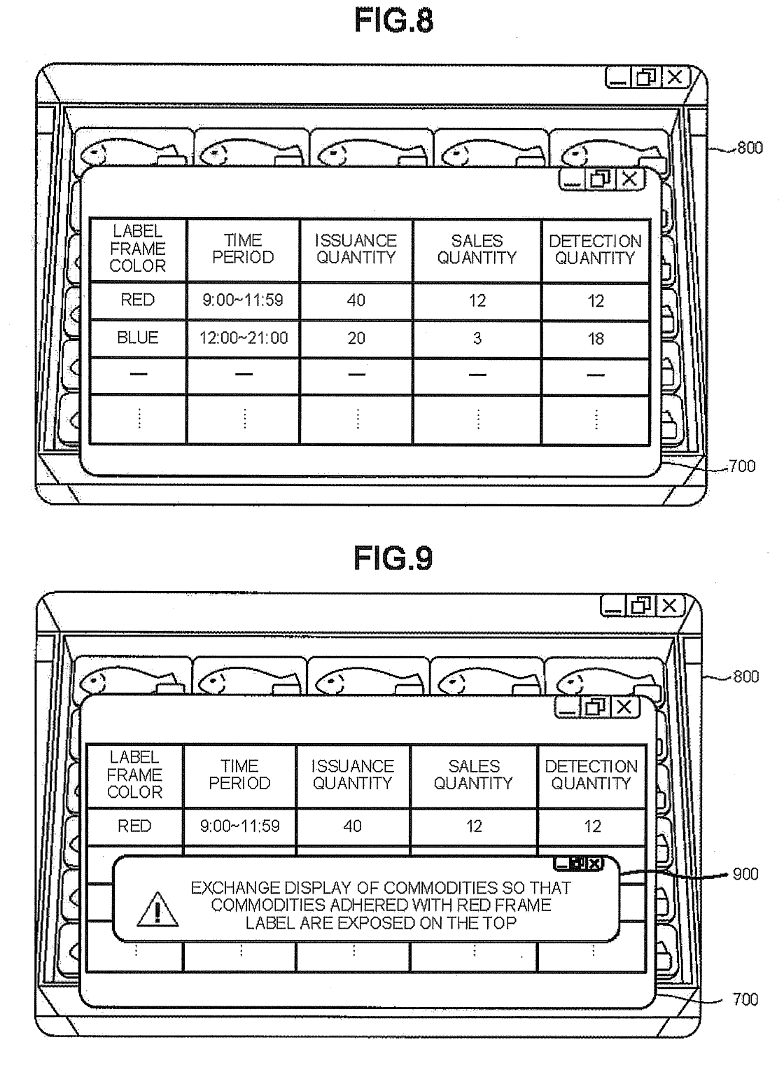

FIG. 8 is a diagram showing an example of the display screen of the display device 2 on which the list image is displayed.

The image displayed in a window 700 is the list image. In addition, in the example shown in FIG. 8, the window 700 is displayed such that it is overlapped on a window 800 displaying the display state image.

In the list image shown in FIG. 8, values of variables L1-Lj are shown in the column represented in a title ‘detection quantity’. Then, in addition to items ‘time period’ and ‘detection quantity’, items ‘label frame color’, ‘issuance quantity’ and ‘sales quantity’ are also shown in the list image shown in FIG. 8.

The CPU 10 acquires ‘label frame color’ and ‘issuance quantity’ from the data table and ‘sales quantity’ from the POS server 300. FIG. 8 shows a display screen that the POS server 300 manages the sales quantity of the commodities for each time period in which labels are respectively adhered to the commodities which are sold. The POS server 300 manages, based on the information acquired from the POS terminal 400 for registering the sales of commodities, the sales quantity of the commodities for each time period in which labels are adhered to the commodities sold. The time period in which labels are respectively adhered on the commodities may be contained in the data represented with a barcode, or determined by the POS server 300 or the POS terminal 400 based on the frame color discriminated by the POS terminal 400. Additionally, if the POS server 300 only manages the total sales quantity but not manages the sales quantity for each time period in which labels are respectively adhered on the commodities sold, then the total sales quantity can be indicated regardless of the time period in which the labels are adhered on the commodities.

By viewing the list image shown in FIG. 8, since there are more new commodities detected than the old ones, the store clerk realizes that there may be a situation that the new commodities are displayed above or before the old commodities. However, according to only the detection quantity, it is difficult for the store clerk to determine whether the above-described situation occurs or the stock quantity of the old commodities is decreased. However, by viewing ‘issuance quantity’ and ‘sales quantity’ contained in the list image shown in FIG. 8, the store clerk can recognize the stock quantity as a difference between the issuance quantity and the sales quantity and thus he or she realizes a situation that old commodities are blocked or covered with new commodities in a case in which the number of the detected old commodities greatly smaller compared with the stock quantity thereof. Since the list image in FIG. 8 contains ‘label frame color’, the frame color of the label adhered on an old commodity can be confirmed, and thus, if the commodities are repositioned, for example, such that old commodities are moved to upper or front sides, or old commodities are sold at a discount, the store clerk can easily determine the old commodity.

Further, by taking the window 800 in active, the store clerk can confirm the display state of commodities without going to the sales place.

In ACT Sb11, the CPU 10 sets the value of a variable m to 1.

In ACT Sb12, the CPU 10 calculates the stock quantity of commodities with a label having a frame color of number m as a difference between the issuance quantity of the label and the sales quantity of the commodity and sets the stock quantity calculated to a variable N. In this way, the CPU 10 functions as a calculation section.

In ACT Sb13, the CPU 10 confirms whether or not the value of the variable N is 0. If the YES is confirmed, that is, there is no stock, then the CPU 10 executes ACT Sb14.

In ACT Sb14, the CPU 10 confirms whether or not the value of the variable m is more than j. If the No is confirmed because the value of the variable m is less than j, then the CPU executes ACT Sb15.

In ACT Sb15, the CPU 10 increases the value of the variable m by 1. Then, the CPU 10 repeats the processing following ACT Sb12. In this way, the CPU 10 determines whether or not there is a stock of the commodity with a label having a frame color corresponding to the color number which is sequentially changed in ascending order. Then, if it is determined for the first time that the commodities with a label having a frame color subject to the determination are in stock, the CPU proceeds to ACT Sb16 from ACT Sb13.

In ACT Sb16, the CPU 10 confirms whether or not the value of the result of the calculation (Lm/N) is smaller than a predetermined threshold value TH. That is, the CPU 10 confirms whether or not the ratio of the number of the commodities detected with a label having a frame color corresponding to the color number m to the stock quantity of the same commodities is smaller than a given value. If YES is confirmed, the CPU 10 executes ACT Sb17.

In ACT Sb17, the CPU 10 generates a guidance image and instructs the display device 2 through the display interface 14 to display the guidance image.

FIG. 9 is a diagram showing an example of the display screen of the display device 2 on which the guidance image is displayed.

The image displayed in a window 900 is the guidance image. In the example shown in FIG. 9, the window 900 is displayed such that it is overlapped on the windows 700 and 800.

It is shown in the guidance image shown in FIG. 9 that the value of the result of the calculation (L1/N) is smaller than the threshold value TH, which prompts the store clerk to change the position of the commodities so that the commodities with a label having a red frame border are exposed on the top. In this way, the CPU 10 executes processing for displaying the guidance image which notifies and prompts the store clerk to change the display position of the commodities, a stock of which is kept and labels of which are adhered at the earliest timing, and thus the CPU 10 functions as a processing section.

Thus, in a case that the number of commodities that are imaged into the display state image is smaller compared with the number of stocks thereof in spite of old commodity, the store clerk can recognize, by viewing the guidance image shown in FIG. 9, to be required to change the display position of such commodities such that those are moved to the upper position. In this way, a case in which old commodities are kept behind new ones can be prevented.

After the display of the guidance image is ended, the CPU 10 ends the commodity management processing. Besides, if YES is determined in ACT Sb14 because of the stock quantity of commodity relating to all the colors set in the data table being 0, and if No is determined in ACT Sb16 because of the value of the result of the calculation (Lm/N) being not higher than the threshold value TH, the CPU 10 passes ACT Sb17, that is, terminates the commodity management processing without displaying the guidance image.

Thus, according to the commodity management apparatus 100 described above, the time and labor of the store clerk in charge of managing the commodities displayed in the display space are saved.

Following modifications may be made to the embodiment.

The store clerk may selectively set a plurality of label papers having different frame colors in the label printer 4 and thus the label printer 4 is not required to print frame border. In this case, a printer for printing a monochromic image may be used as the label printer 4.

Objects of which colors are different corresponding to the time period at which labels are adhered may take any shape. For example, the color of a barcode may change according to the time period at which labels are adhered. That is, such barcode can be used as not only a data carrier but also the above-described object. Further, marks and letters in a specific shape may also be used as the object.

The detection quantity (the number of detections) may be stored in the RAM 12 or the auxiliary memory unit 13 and then, in response to a request from the POS server 300, the POS terminal 400, or other terminal device not shown in the figures, the stored detection quantity is notified to the source of the request. In this case, the list image and the guidance image may not be displayed.

The list image and the guidance image may be displayed by the POS server 300, the POS terminal 400 or other terminal device not shown in the figures.

Alternatively, only the list image is displayed but the guidance image may not be displayed.

The commodity management apparatus 100 may be constructed without camera 5, but other camera device such as a security camera may be used as camera 5, as well.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity management apparatus, comprising:
an extraction section configured to extract a plurality of objects shown in a display state image which is obtained by color-photographing a display space in which a plurality of commodities are displayed, the plurality of commodities respectively having labels which indicate objects of different colors according to each timing period at which labels are respectively adhered to the commodities;
a discrimination section configured to discriminate color of each object extracted by the extraction section; and
a counting section configured to respectively count the plurality of objects extracted by the extraction section according to each color discriminated by the discrimination section.

2. The commodity management apparatus according to claim 1, further including a generation section configured to generate a list image in which the number of counts counted by the counting section for each color of the objects is shown in association with the color of the objects or the timing periods, at which labels are respectively adhered to the commodities, relevant to the color of the objects.

3. The commodity management apparatus according to claim 2 further including a first memory configured to store an issuance quantity of the label for each color and a second memory configured to store a sales quantity of the commodity for each timing period at which the labels are adhered to the commodities, respectively.

4. The commodity management apparatus according to claim 3, wherein the generation section generates the list image in which the issuance quantity of the label stored in the first memory is shown in association with the number of counts counted by the counting section for each color of the objects.

5. The commodity management apparatus according to claim 3, wherein the generation section generates the list image in which the sales quantity of the commodity stored in the second memory is shown in association with the number of counts counted by the counting section for each color of the objects.

6. The commodity management apparatus according to claim 3 further including a calculation section configured to calculate a stock quantity of the object based on the issuance quantity of the label stored in the first memory and the sales quantity of the commodity stored in the second memory, and a processing section configured to carry out a notifying processing for prompting a parson to rearrange the commodities in accordance with a case in which a ratio between the number of objects counted by the counting section and the stock quantity calculated by the calculating section is smaller than a prescribed threshold value.

7. The commodity management apparatus according to claim 3, further including a calculation section configured to calculate a stock quantity of the object for each color based on the issuance quantity stored in the first memory and the sales quantity stored in the second memory, and a processing section configured to carry out a notifying processing for prompting a person to rearrange the commodities in accordance with a case in which a ratio between the number of objects counted by the counting section relating to the color of the object assigned to the earliest timing period at which the labels are adhered to the commodities within the colors of the object of which the stock quantity calculated by the calculating section is other than zero and the stock quantity of the object counted by the counting section relating to the object having a color the same as that subject to the count by the counting section is smaller than a prescribed threshold value.

8. The commodity management apparatus according to claim 1, further including a color-photographing unit configured to photograph the display space to obtain the display state image in color.
